(19) United States
(12) Patent Application Publication
(10) Pub. No.: US 2010/0153528 A1
(43) Pub. Date: Jun. 17, 2010

(54) Devices, Systems and Methods for Controlling Network Services Via Address Book

(75) Inventors: Larry B. Pearson, San Antonio, TX (US); Ronald Barchi, Maple Valley, WA (US)

Correspondence Address: AT&T Legal Department - Moazzam;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/336,525

(22) Filed: Dec. 16, 2008

(51) Int. Cl. G06F 15/16; G06F 17/30

(52) U.S. Cl. 709/223; 707/E17.009

(57) ABSTRACT

Devices, systems and methods are disclosed which relate to analyzing an electronic address book for a change which impacts a service, and updating the service. An analysis engine monitors the electronic address book for changes, then evaluates whether each change impacts a service. If the change does impact a service, a reaction engine applies that change to the service. The change can be a new telephone number for an existing contact, a new group applied to a contact, a new permission for a contact, etc. These changes potentially impact a service such as caller restriction, find me/follow me, photo sharing, etc. The reaction engine applies the change to a network controller ultimately in control of the service.

### BACKGROUND OF THE INVENTION

1. Field of the Invention

The present invention relates to changes to a service. More specifically, the present invention relates to analyzing an electronic address book for a change which impacts a service.

2. Background of the Invention

Today's telephone systems have complex call controls. Call controls are systems that can reroute calls based on rules that are either supplied by the system or the end user. For example, a very simple rule is the end user only wants to take calls from the telephone numbers on a specified list, like an access control list. The end user builds the list, and a network controller stores the list. When someone dials the end user's telephone number, the network controller matches that person's telephone number with the end user's access control list. If that person's telephone number appears on the access control list, the call is allowed. If not, the call is not allowed.

Another example of a call control is a “find me/follow me” service, or as Voice over internet protocol (VoIP) systems call it, a VIP service. Here the end user selects telephone numbers on a list. The end user also builds a list of his or her alternate telephone numbers, such as home, mobile, office, car, etc. If someone on this list calls the end user and the end user does not answer, the network controller dials the end user's other telephone numbers until the end user is reached. For instance, if the end user does not answer the office telephone, it will ring his mobile telephone. If the end user does not answer his mobile telephone, the network controller will redirect the call to his office telephone, and so on. A list for this service is normally kept to a minimum since the end user does not want anyone to be able to reach him at any time.

A problem in general is that if one of the end user's contacts changes their telephone number, there is no automatic way to go back and update that call control list. The problem increases as the end user gains more complicated kinds of call controls. Especially, for instance, keeping a home telephone number on a call control list when the end user's family changes location often. Each time the family moves, the home telephone number changes, and each call control list that features the home telephone number needs to be updated.

Address books are structured in many advanced ways. Typically, there are multiple views to the address books of many devices. An address book can be viewed flat, in alphabetical order, by location, in groups, etc. There can be groups or categories within an address book, such as friends, family, office, company, etc. An end user may want a group to always reach him, such as his family, or perhaps more specifically his immediate family. This becomes more complicated as the end user adds more complex structure to his address book. The end user may have groups that contain other groups. For example, an end user may have a “work” group, and within that a sub-group of his individual team or leadership chain. The end user wants his supervisor, manager, and the owner to be able to reach him at any time day or night. An end user might have different groups within his business organization, but with different meanings and different availabilities for each group within the business organization. The same thing can be true with end user's family, civic organizations, etc.

There are a variety of different ways to represent information in an address book and the relationships within the address book. A single contact might belong to multiple groups, such as a friend, who is also a coworker, who is also in your chain of command. A peer in a “work” group might also be a relative. Things are complicated from a call control standpoint with an address book such as this, and there is a need for a way for address book changes to percolate intelligently into your call controls.

At the same time, network address books are gaining popularity. A network address book is one address book that is contained in a network that pushes itself out to all the devices a user owns so that all contact information is uniform across these devices. Synchronization is supported, so if you change a contact's e-mail address, the change will automatically update a master copy stored on a network. From that master copy on the network, all the other devices may synchronize and realize the same change in the individual device address books. The end user can change the address book with any of the devices and the network will make the change across all of them. The master copy can also be accessed from any computer connected to the internet upon providing credentials.

There is a need for a way of updating all of the kinds of call controls that need to be updated when there is a change in an address book. If the end user has a group that he always wants to be able to reach him, then anytime a telephone number changes or a change occurs within a single contact of that group it needs to be automatically reflected in his call control.

### SUMMARY OF THE INVENTION

The present invention is a system and a method for analyzing an electronic address book for a change which impacts a service, and updating the service. An analysis engine monitors the electronic address book for changes, then evaluates whether each change impacts a service. If the change does impact a service, a reaction engine applies that change to the service. The change can be a new telephone number for an existing contact, a new group applied to a contact, a new permission for a contact, etc. These changes potentially impact a service such as caller restriction, find me/follow me, photo sharing, etc. The reaction engine applies the change to a network controller ultimately in control of the service.

In one exemplary embodiment of the present invention, the invention is a system for updating a service in response to an address book change, comprising a communication device, an electronic address book accessible by the communication device, an analysis engine in communication with the electronic address book, a reaction engine in communication with the analysis engine, and a network controller in communication with the reaction engine. The analysis engine monitors the electronic address book for changes that impact a service, and the reaction engine updates the network controller when such a change occurs.

In another exemplary embodiment of the present invention, the invention is a system for updating a service in response to an electronic address book change, comprising an electronic address book, a server in communication with the electronic address book, a logic on the server for monitoring and evaluating a change to the electronic address book, and a network controller in communication with the server. The logic evaluates whether the change impacts a service and updates the service on the network controller.

In a further embodiment of the present invention, the invention is a method for updating a service in response to a change in an electronic address book, comprising evaluating whether a change impacts a service, monitoring an electronic address book for the change, and updating the service with the change.

### BRIEF DESCRIPTION OF THE DRAWINGS

FIG. 1 shows a mapping of household members to services.

FIG. 2 shows an example of a portal, which is how a consumer VoIP service Member Account Manager (MAM) module allows a primary account holder or head of household to set an order of importance.

FIG. 3 shows an object model of the relationship between different data objects within an address book.

FIG. 4 shows an example of a system for automated synchronization of an address book, according to an exemplary embodiment of the present invention.

FIG. 5 shows a registration event in the system, according to an exemplary embodiment of the present invention.

FIG. 6 shows a system in which a “modification in telephone number” event occurs, according to an exemplary embodiment of the present invention.

FIG. 7 shows cascading events resulting from an endpoint address change, according to an exemplary embodiment of the present invention.

FIG. 8 shows sample pseudo code for calculating a service configuration based on the rules outlined in the description of FIG. 7.

FIG. 9 shows a high-level system implementing changes to a network service in response to address book changes, according to an exemplary embodiment of the present invention.

FIG. 10 shows an event registration sequence diagram, according to an exemplary embodiment of the present invention.

FIG. 11 shows a user interface (UI), according to an exemplary embodiment of the present invention.

FIG. 12 shows a contact in an address book UI, according to an exemplary embodiment of the present invention.

FIG. 13 shows a user interface with system defined groups (SDG), according to an exemplary embodiment of the present invention.

FIG. 14 shows a typical implementation of a provisioning system according to an exemplary embodiment of the present invention.

FIG. 15 shows the base network address book logical design, according to an exemplary embodiment of the present invention.

FIG. 16 shows the tables required to support the groups of groups feature of the address book, according to an exemplary embodiment of the present invention.

FIG. 17 shows an extension of the event model which covers Publish/Subscribe events, according to an exemplary embodiment of the present invention.

FIG. 18 shows a pseudo-code for a contacts trigger, according to an exemplary embodiment of the present invention.

FIG. 19 shows a pseudo-code for a contacts trigger executed when a contact is updated, according to an exemplary embodiment of the present invention.

FIG. 20 shows a pseudo-code for a contacts trigger executed when a contact is deleted, according to an exemplary embodiment of the present invention.

FIG. 21 shows a pseudo-code for a trigger executed when a contacts trigger is executed when a contact is inserted, according to an exemplary embodiment of the present invention.

FIG. 22 shows a pseudo-code for a trigger executed when a contacts trigger is executed when a contact is deleted, according to an exemplary embodiment of the present invention.

FIG. 23 shows a system alert for deferred configuration, according to an exemplary embodiment of the present invention.

### DETAILED DESCRIPTION OF THE INVENTION

The present invention is a system and a method for analyzing an electronic address book for a change which impacts a service, and updating the service. An analysis engine monitors the electronic address book for changes, then evaluates whether each change impacts a service. If the change does impact a service, a reaction engine applies that change to the service. The change can be a new telephone number for an existing contact, a new group applied to a contact, a new permission for a contact, etc. These changes potentially impact a service such as caller restriction, find me/follow me, photo sharing, etc. The reaction engine applies the change to a network controller ultimately in control of the service.

“Endpoint address,” as used herein and throughout this disclosure, refers to a place where things can be delivered, either information or real, physical things. Examples of an endpoint address are a home phone number, cellular telephone number, work telephone number, e-mail address, instant messaging name, home street address, business address, web URL/URI, location identifier, location coordinates, etc.

“Service,” as used herein and throughout this disclosure, refers to any access controlled connection between communication devices. Examples of a service are find-me/follow-me, ring-back tone, picture sharing, video conferencing, selective call acceptance, selective call rejection, etc.

“Communication Device,” as used herein and throughout this disclosure, refers to any device capable of sending and receiving information. Examples of a communication device include a cellular telephone, a PDA, a computer, a landline telephone, etc.

“Electronic address book,” as used herein and throughout this disclosure, refers to a collection of endpoint addresses categorized in any number of ways and stored on an electronic medium. An electronic address book can be stored on a communication device.

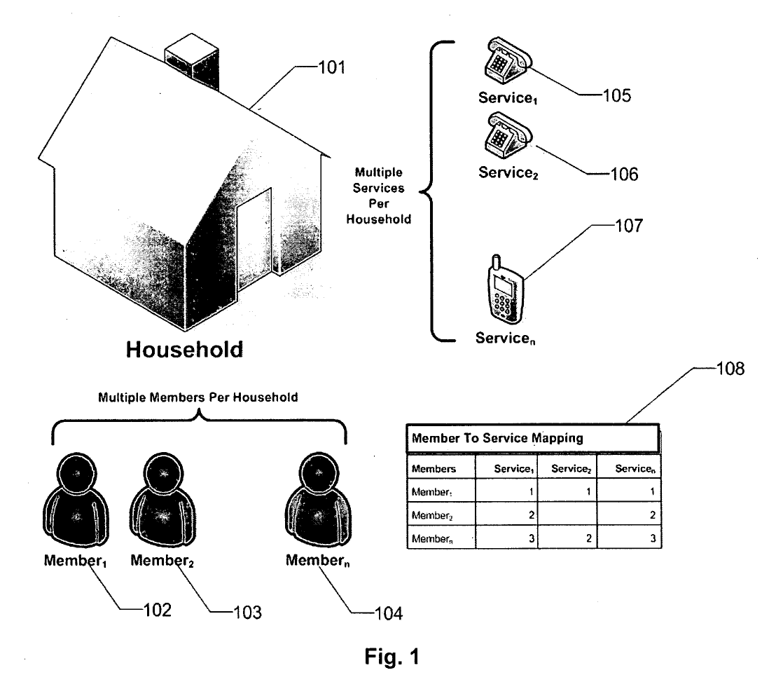

FIG. 1 shows a mapping of household members to services. This figure uses the example of address book controls of telephone service, and provides a framework for the present invention. The same framework also applies on a larger scale, such as a business, or a smaller scale, such as a partnership. Members of the household 101, member₁ 102, member₂ 103, up to memberₙ 104, are each paired with services 105-107 within household 101. These services may be a landline home telephone service 105, a landline business telephone service 106, a cellular telephone service 107, etc. Members who have access to each service may be set, with certain members having control of the service over others.

Depending on how the administrators have structured the address book, information is categorized in many ways, such as contacts, groups of contacts, and groups of groups. While the figure shows a linear relationship, the actual data doesn't have to be linear, it can be hierarchical.

Each member has their own address book, although some of the contacts may be shared. Members also map to different services. Each member has one set of call controls that control each service mapped to that member. Within a household, more than one set of call controls may apply to the same service, such as a home telephone service. Generally, one member is not a user of the other member's cellular telephone. Therefore, call controls of one member do not apply to the other's cellular telephone. However, from a household perspective, rules on the shared home telephone must be established according to a hierarchy.

An example of household member to service mapping is the consumer VoIP service Member Account Manager (MAM) 108. MAM 108 provides member to service mapping to Consumer VoIP (CVoIP). A co-pending application, U.S. Ser. No. 11/530,578, filed Sep. 11, 2006, and entitled, “Methods and Apparatus to Provide a Telephone System Configuration Interface”, describes this concept in more detail, and is incorporated by reference herein in its entirety. The MAM solution provides mapping between members, telephone numbers, and Unified Messaging (UM) mailboxes.

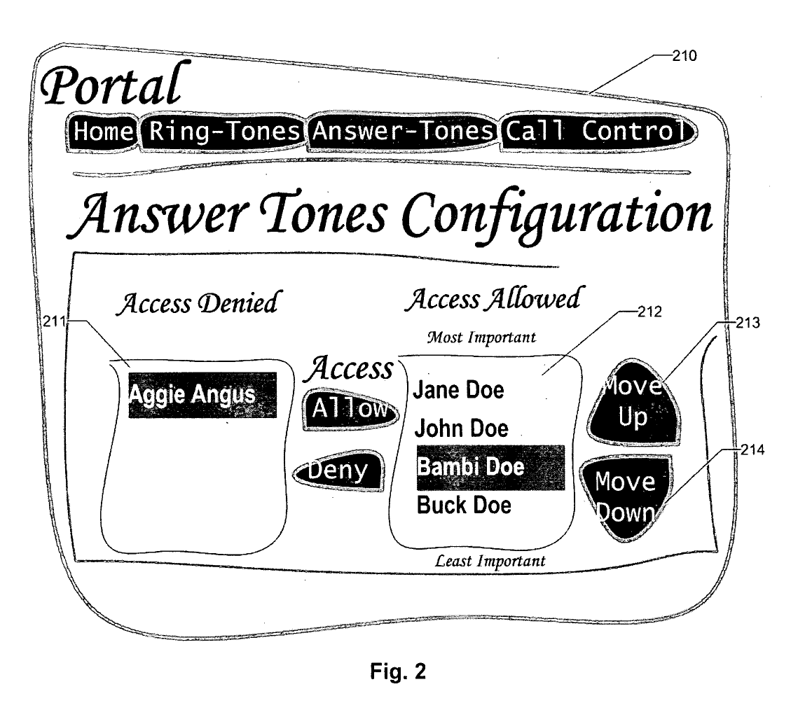

FIG. 2 shows an example of a portal 210, which is how MAM allows a primary account holder or head of household to set an order of importance 212. In this example, an ring-back tone configuration for an address book controls access to ring-back tones and declares a hierarchy of members. Ring-back tone Ring-back tones play a tone or music clip to a caller as the caller is waiting to connect to a member. Because this ring tone is being heard by the caller, the primary account holder of the service may want to limit what other users of the service choose as the tone. For example, a parent may not want their child to select music clips that will be played as ring-back tones on the family home telephone. The primary account holder may establish a hierarchy of selection for a mutually used device, such as a home telephone, or may deny access to certain members altogether. Parental controls are flexible, customizable, and user configurable. In this example, hierarchy 212 is established by highlighting a member and selecting either “move up” 213, which elevates that member in hierarchy 212, or “move down” 214, which lowers that member in hierarchy 212. The system aggregates an address book controlled service similar to this ring-back tone example.

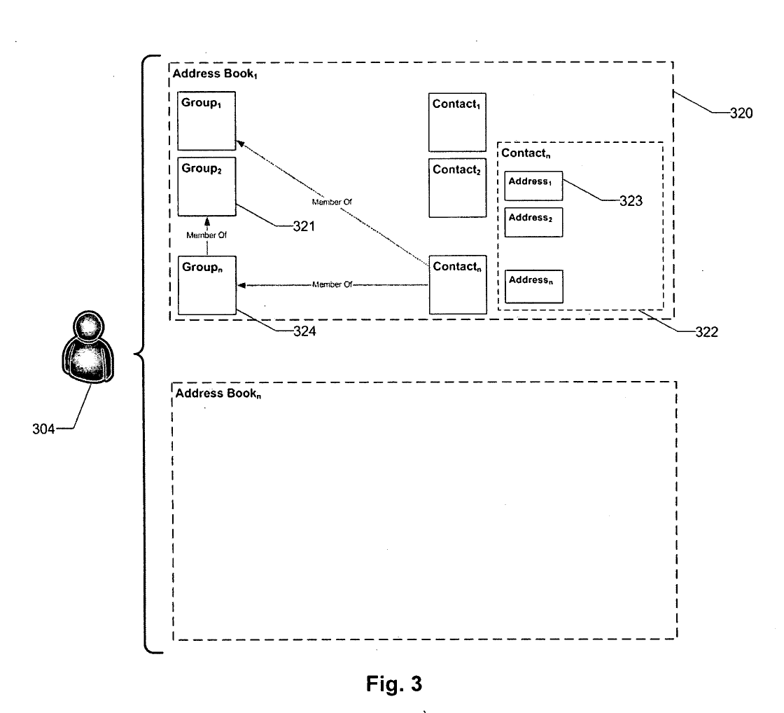

FIG. 3 shows an object model example of the relationships between different data objects within an address book. Contacts 322, groups 321, and endpoint addresses 323 are all within an address book 320. Contact 322 contains three endpoint addresses. Endpoint address 323 is a home phone number, while the other two are a cellular telephone number and an e-mail address. Contact 322 is located within two groups. Group 324 is located within group 321. Address book 320 contains three groups.

Contacts may each contain zero or more endpoint addresses. For instance, for a contact, a user may have a home phone number, cellular telephone number, work telephone number, e-mail address, instant messaging name, home street address, business address, web URL, etc. Contacts can be located within zero or more groups. This may be two groups or ten groups, but a contact can have more than one group. Groups may also be located within another group. An address book contains zero or more of these groups.

With an application such as one that sets up ring-back tones or a list of preferred callers, the service may have a web user interface (WUI). The WUI allows a user to configure the user's service. For instance, the user may want to allow all co-workers to utilize a find me/follow me service. The user may also want all co-workers to get a professional ring-back tone, as opposed to something less appropriate. The user may want his brother to hear Janis Joplin belting out “Oh Lord Won't You Buy Me a Mercedes Benz?” as an ring-back tone. The same ring-back tone would likely not be appropriate when a supervisor calls. The user may also wish to have his address book automatically updated in the event of a change in a group, contact, or address in the user's address book.

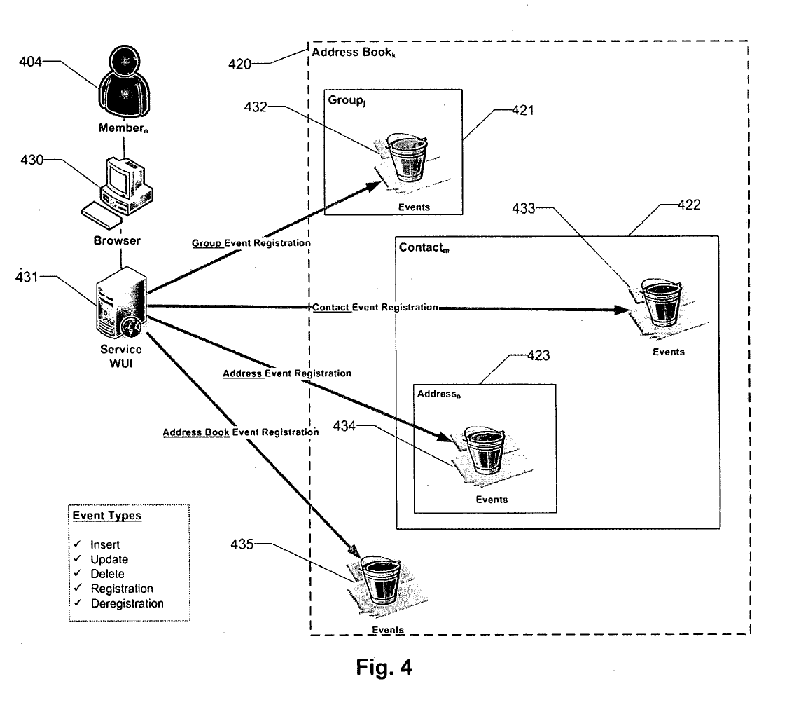

FIG. 4 shows an example of a system for automated synchronization of an address book. In this example, the system comprises a browser 430, a service WUI 431, and an address book 420 including a group 421, a contact 422, and an endpoint address 423. Upon an event, such as a modification of contact 422 within address book 420, the system automatically synchronizes any other address books in the system, such as member 404's other communication devices. This may include address books or devices which are registered to synchronize based on changes to member 404's address book. For instance, if member 404's brother changes his telephone number and member 404 is registered to synchronize with his brother's endpoint address, then member 404's address book is synchronized with the new telephone number when his brother changes it. The synchronization can occur immediately, periodically, or be deferred until member 404's direction.

An event, such as a modification of any of the properties or entries in an address book, automatically synchronizes any other address books in the system. Other types of events include insert, update, delete, registration, deregistration, etc. For example, a registration event in the “family” group provides for an alert to the system whenever the “family” group is modified. The system then informs the service that created the registration event of the modification. With this information, the service updates based upon programmed preferences. These preferences may be automatically programmed through the service, by the user, etc.

Likewise, an event registration may be for a specific contact, including all of the endpoint addresses contained within the contact, or even down to a specific endpoint address. For instance, a user may have registered an event for a friend's cellular telephone number, but not for that friend's home telephone number. A change to the friend's cellular telephone number does not affect the same event registration as a change to the friend's home telephone number. Therefore, if the friend changes the cellular telephone number, the new cellular telephone number is updated into the user's address book. However, if the friend's home telephone number changes, the new home telephone number is not updated into the user's address book unless the user registers for that event also.

Additionally, the user may want any change of his address to be reflected in a service. For example, the user might have a find me/follow me service allowing anybody that is in the address book to utilize it while everyone else goes to voicemail. An event is registered by the find me/follow me service to the entire address book. When an endpoint address in the address book changes, the find me/follow me service is informed of this change and automatically updates to match the modified address book. These event registrations by services form the analysis engine.

Address book changes occur through a device, WUI, as a result of synchronization to an external address book, etc. With an event already registered for changes in an address book, a change in the address book triggers the reaction engine. When the change occurs, the address book database determines if there is an event registered for changes of that type. If there is an event registered, the reaction engine sends the event notification plus the change to a network service where the network service can then decide what changes are necessary. Two very distinct systems communicate with each other, the analysis engine and the reaction engine.

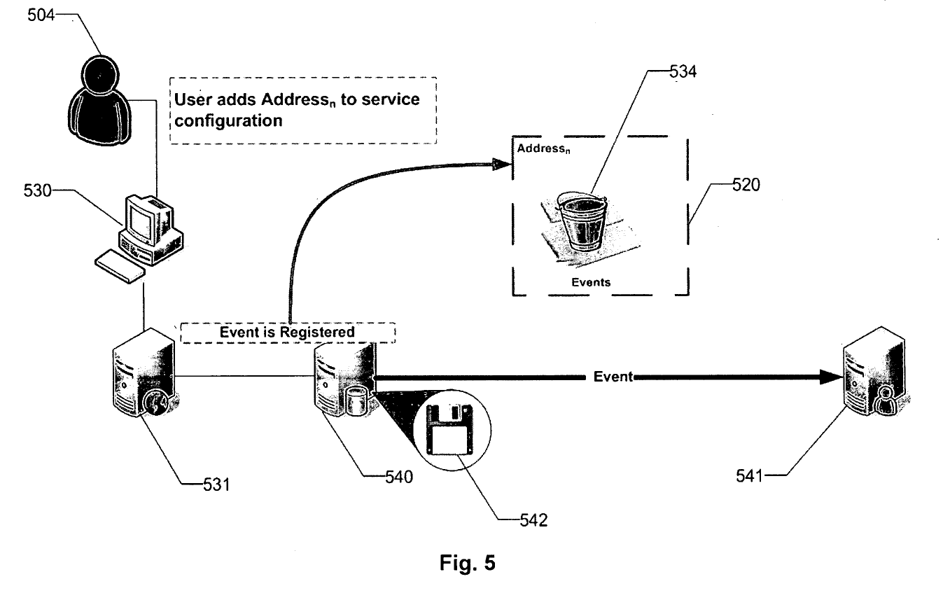

FIG. 5 shows a registration event in the system, according to an exemplary embodiment of the present invention. In this embodiment, the system comprises an address book 520, a browser 530, an address book WUI 531, an address book server 540, a logic 542 onboard address book server 540, a network service 541, and an event 534. Logic 542 comprises an analysis engine and a reaction engine. When a user 504 adds an endpoint address to network service 531 through browser 530, the system registers event 534 with address book WUI 531 into a database onboard address book server 540. Event registration gives the analysis engine awareness of changes. The reaction engine implements the changes in network service 541. Network service 541 receives the change from address book server 540. Then network service 541 recalculates and makes any needed changes in the service configuration.

Event registration causes services to be notified of new configurations. Deregistration removes a previous registration and turns off service configuration change notification.

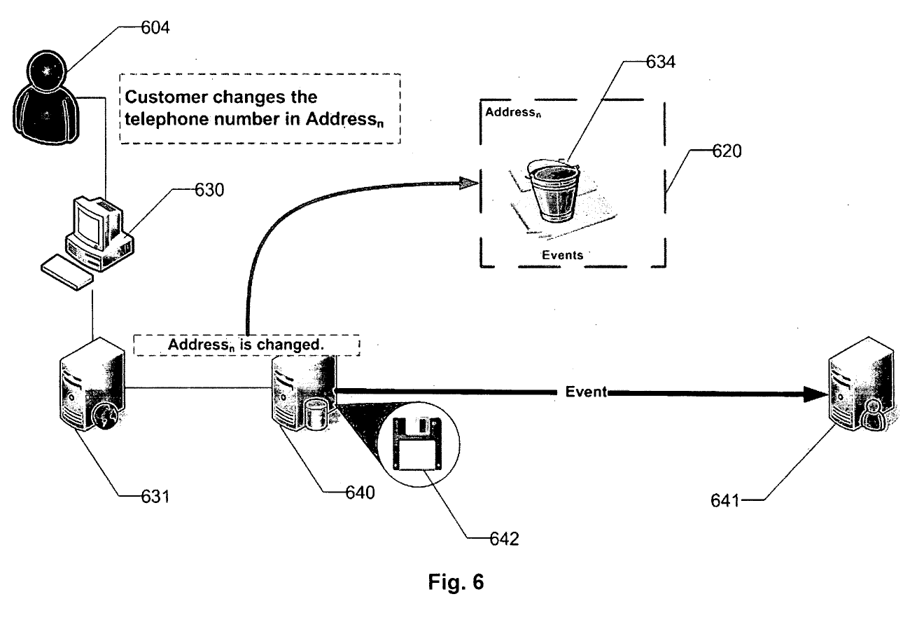

FIG. 6 shows a system in which a “modification in telephone number” event occurs, according to an exemplary embodiment of the present invention. In this embodiment, the system comprises an address book 620, a browser 630, an address book WUI 631, an address book server 640, a logic 642 onboard address book server 640, a network service 641, and an event 634. A user 604 makes a modification to a telephone number within user 604's address book. The change to address book 620 matches the “modification in telephone number” event within address book server 640, and a message is sent to network service 641 identifying the service, user, change, and event type. Event 634 results in a configuration change. Thus, network service 641 responds to the user supplied configuration instructions and modifies the telephone number registered to network service 641.

When a change to an address book matches a registered object within an address book server, a message is sent to the network service, or feature of the network service, identifying the service, user, change, and event type. If the event results in a configuration change, the network service responds to the user supplied configuration instructions and inserts, updates, or deletes the endpoint address registered to the network service.

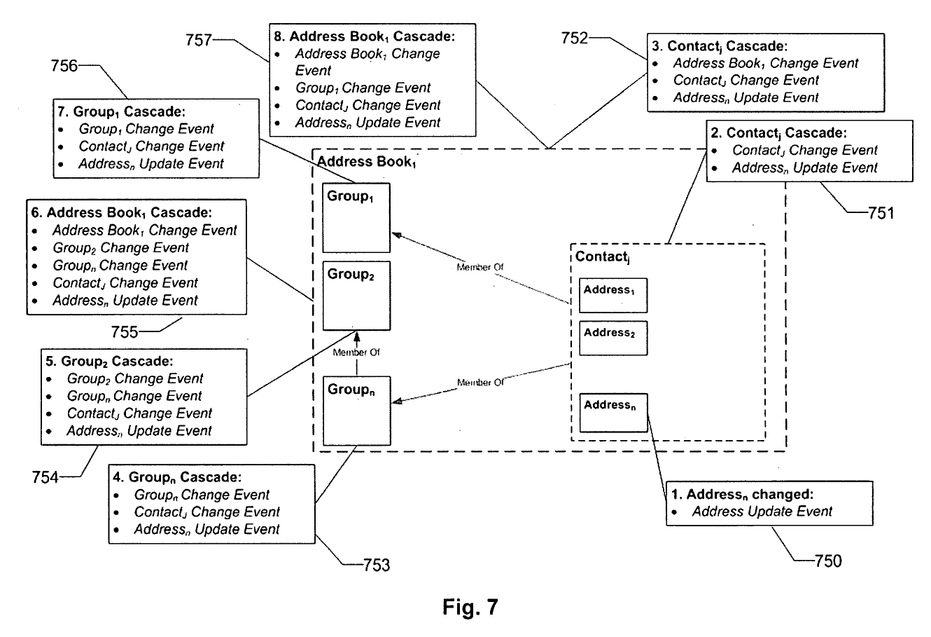

FIG. 7 shows cascading events resulting from an endpoint address change, according to an exemplary embodiment of the present invention. Address Book change events cascade following relationships described in the model in FIG. 3. When an endpoint address is inserted, updated, or deleted, a check is made to see if any services, or service features, have registered for events on that specific endpoint address object. If a service is registered for the event type, a message is sent to the service. A corresponding insert, update, or delete event is also generated for the contact containing the endpoint address. Next, each group the contact is contained within is notified of an endpoint address change event. Then, the address book containing the contact is notified with an endpoint address change event. Also, each group that the changed group is contained within is notified with an endpoint address change event. Registration and deregistration events do not cascade and only trigger event notification to the registering or registered service.

There are different ways to do these cascades based on the structure of the address book. Contact cascade 751 alerts when there is a change to anything contained within the contact. Other than endpoint addresses, there is also name information, birthday, picture, etc. If anything changes in that contact including the endpoint addresses that are contained within it, then contact change events and address update events are triggered. These triggered events initiate a contact level event, which can be split into two types of events: Contact change events, such as name, birthday, sex, salutation, and endpoint address update events, such as phone number change, U.S. postal address changes, e-mail address changes, IM changes, mobile phone number changes, etc. The next layer 752 is an address book change event.

A service registered to an endpoint address, contact, group, and address book objects can receive multiple event notifications because of a single change. System implementers may choose to aggregate multiple events around a single root event and present event notification to registered services. An aggregated event notifies a single service of changes to multiple registered objects. For example, combining information provided in call out boxes 752, 755, and 757 provides a single consolidated event. For household subscribers, services, or service features, calculate service configurations by applying address book data from each household member in the following order: member, endpoint address, contact, group, address book.

More important members' configurations receive first consideration. Endpoint address information is more specific than contact information. Contact information is more specific than group information. Group information is more specific than address book information. Other than “by member” first, the application order goes from most specific to most general. For example, a member wants all callers in their “friends” group to hear the ring-back tone “Sweet Home Alabama.” The member also wants their special friend to hear “I Walk the Line.” The special friend is also a member of the “friends” group. Generally, members want more specific preferences to trump less specific preferences. Thus, “I Walk the Line” is the ring-back tone when the special friend calls, even though the special friend belongs to the “friends” group because contact preferences are more specific than group preferences. When any other contact in the “friends” group calls, “Sweet Home Alabama” is the ring-back tone.

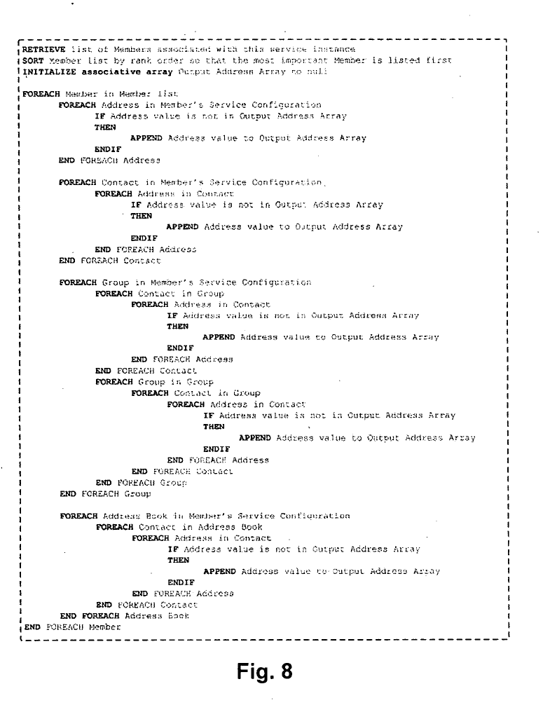

FIG. 8 shows an example of pseudo code for calculating a service configuration based on the rules outlined in the description of FIG. 7. In this example, the Address value is always appended to the Output Address Array. This is helpful when the provisioned service limits the number of addresses. For example, a Selective Call Forward (SCF) list is limited to a total of twenty telephone numbers. A programmer can implement this code within the database.

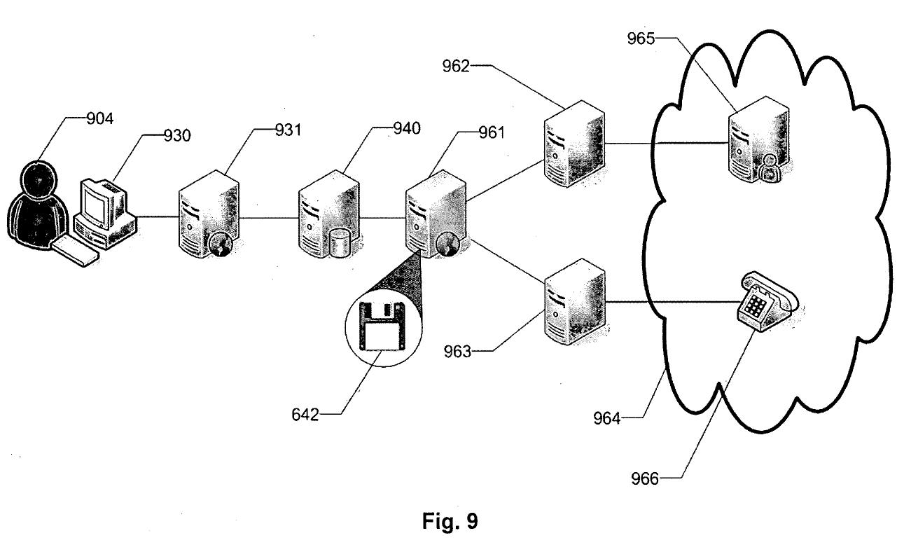

FIG. 9 shows a high-level system for implementing changes to a network service in response to address book changes, according to an exemplary embodiment of the present invention. This embodiment implements a Network Element & Network Endpoint (NE²) Integrator 961 and two provisioning interfaces 962 and 963. NE² Integrator 961 incorporates a logic 942 which provides analysis and reaction functions. For instance, a user 904 configures services using user 904's address book. Services are associated with address book objects using event registration. Registered address book change events trigger service reconfiguration, as shown in FIG. 7. Service changes generate provisioning changes.

For many network services, such as telephone network based services, in order to effect a service change like telephone number ring-back tones, a provisioning step is required. Logic 642 onboard NE² Integrator 961 affects the change on network element 965. Instead of performing an event notification from address book server 940 where the data change is first observed, NE² Integrator 961 notifies the correct network element. NE² Integrator passes it through provisioning agent 962 for network element 965. In further embodiments, the network element integrator is incorporated into a provisioning agent.

The network element changes the behavior of the network. The network can be a telephone network, an internet network, an e-mail network, etc. In the case of the telephone network, the initiation of an ring-back tone is performed purely in the network without a need for the network endpoints. When a contact paired with an ring-back tone changes telephone numbers, a change must be made to the underlying network. When a contact, set to forward automatically to voicemail, changes telephone numbers, the change must be provisioned in the network element that controls calls. The contact's new telephone number must be updated on the network element so that when the contact calls from the new telephone number, the contact is still forwarded to voicemail. The forwarding is done by the network, not at the user's telephone.

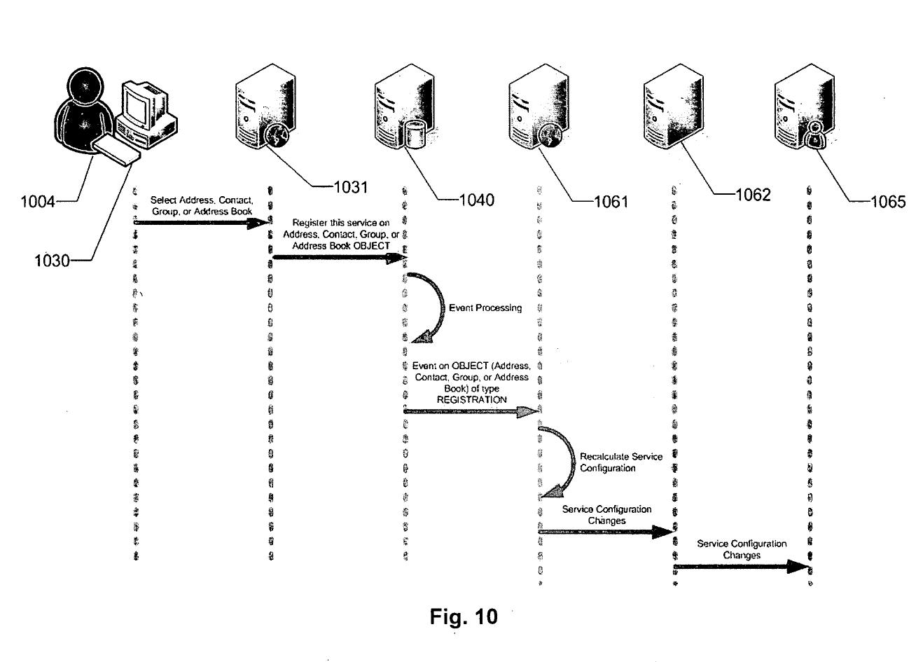

FIG. 10 shows an event registration sequence diagram, according to an exemplary embodiment of the present invention. When a user makes a change to the service, the service registers an event in the address book object. Whenever a change occurs in that object of the address book, the NE² Integrator is alerted, which sends the change to the appropriate network element.

Unlike address book data changes, event registration and deregistration events do not cascade. Only address book data (groups, contacts, and addresses) insert, update, and delete events cascade. Registration and deregistration events configure services using the address book. The Service Web User Interface (WUI) does not need to access the NE² Integrator for service configuration. The Service WUI may access the NE² Integrator to get low-level configuration information. In addition, the NE² Integrator may access the Address Book Database to get multiple member address books. There are multiple ways to integrate the address book into a service's user interface. There are also multiple ways to integrate a service into the address book user interface.

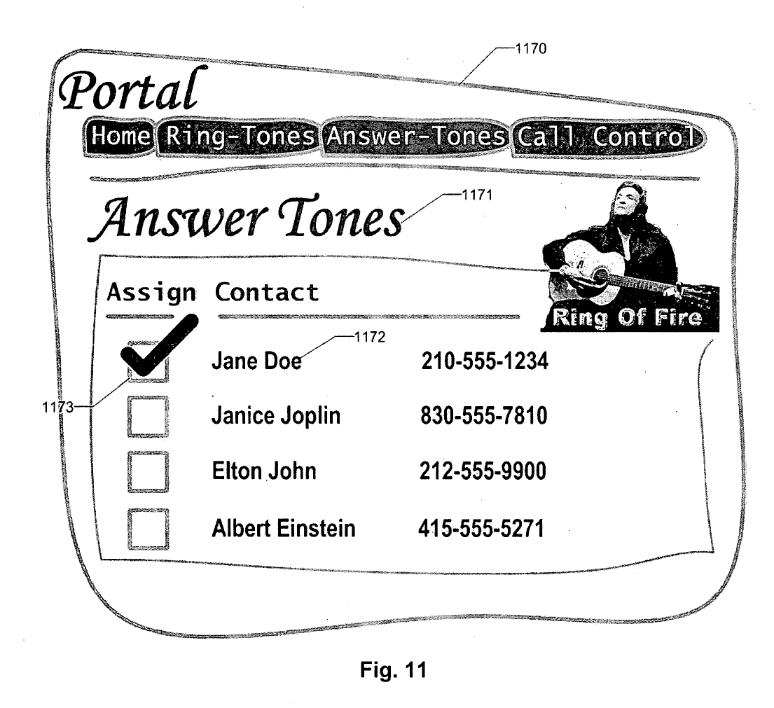

FIG. 11 shows a user interface (UI) 1170, according to an exemplary embodiment of the present invention. In this embodiment, UI 1170 allows for integration between services and the user's address book. UI 1170 comprises a contact 1172, a selected service 1171, and an assignment box 1173. A user elects to assign service 1171 to contact 1172 by checking assignment box 1173. Service UI 1170 implements an address book browsing function. A user selects address book objects from a list of objects within service UI 1170. The user selects the Jane Doe contact 1172. The service registers an event on the address book object. In this embodiment, service 1170 registers with the Jane Doe contact 1172. Contact registration generates a registration event. The registration event passes contact 1170 information to the network service. Integrating a network service into the address book interface may require changes to the address book. Different user interfaces may be necessary to support each integrated service.

A user may also want to enter address information and enable services for the endpoint address at the same time. This may be for a single service or for multiple services available for use with the endpoint address. This type of interface allows a user to see the features associated with each endpoint address. The service can see changes to the address book because it has these events registered to it. Therefore, the address book UI has a view of services using the address book for a particular contact. This combines a service view of the world with a contact view of the world. A user may want to see both sets of information. The prominent features on a user interface may vary, depending on the user preferences, type of service, etc.

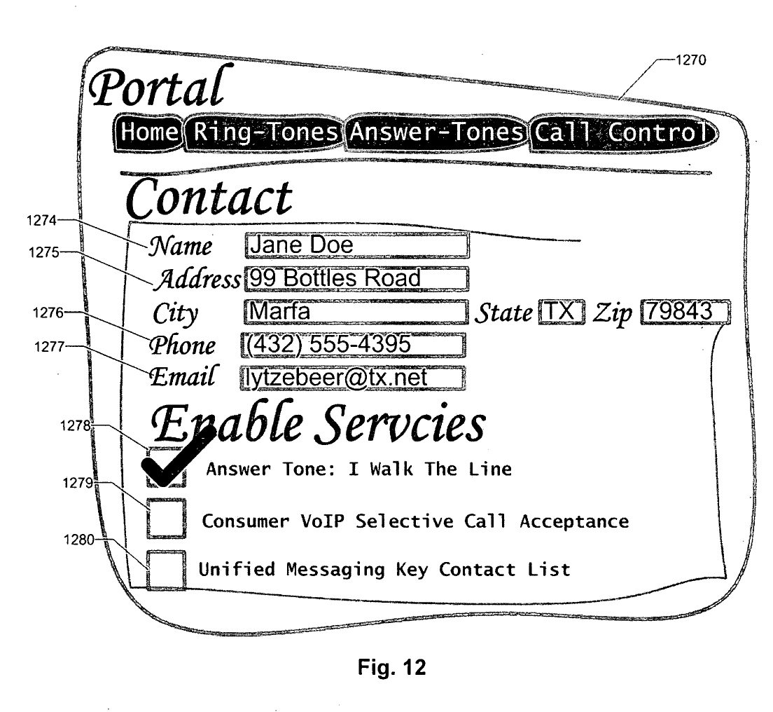

FIG. 12 shows a contact in an address book UI 1270, according to an exemplary embodiment of the present invention. In this embodiment, UI 1270 includes contact information, such as name 1274, mailing address 1275, telephone number 1276, e-mail 1277, etc. UI 1270 also includes the services enabled for the contact, such as an ring-back tone 1278, Consumer VoIP Selective Call Acceptance 1279, and Unified Messaging Key Contact List 1280. When displaying an address book object, the address book generates and displays all of the available service controls that apply to that object. Selecting ring-back tone 1278 causes the service to register the event on the address book object, Jane Doe.

In embodiments of the present invention, a Network address book implements address book controls over services within the address book UI using System Defined Groups (SDG). In this scenario, a contact or group that is a member of an SDG is automatically part of the service configuration.

User interfaces for services may add System Defined Groups (SDG) to the user's address book. After the SDG exists in the address book, the service registers an event for the SDG. These steps occur during the initial service provisioning or later during service configuration. Any subsequent user activity, such as adding contacts or groups to the SDG, generates events.

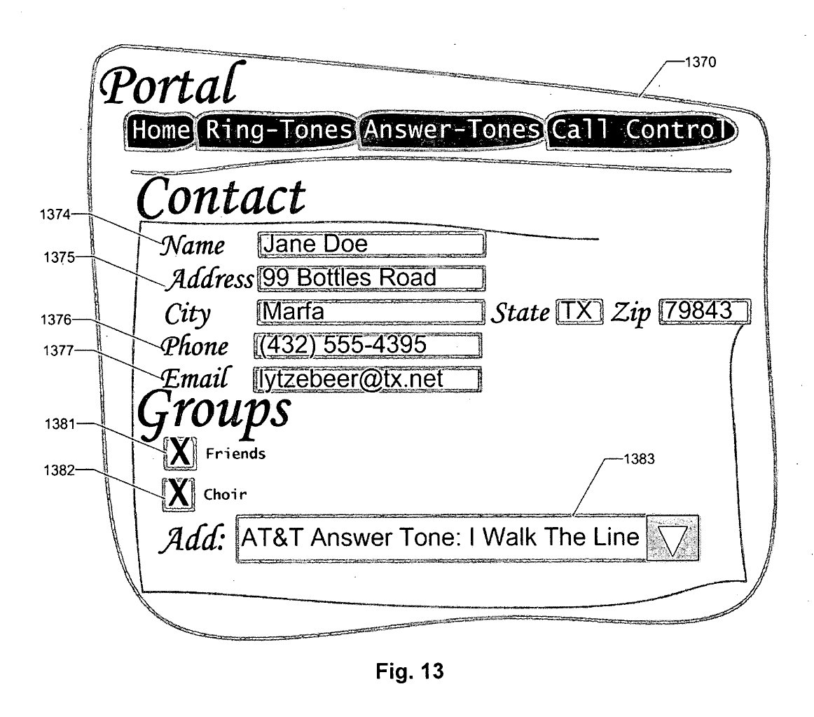

FIG. 13 shows a user interface with system defined groups (SDG), according to an exemplary embodiment of the present invention. In this embodiment, UI 1370 includes contact information, endpoint addresses, a user group 1381, and a selection scroll 1383. Contact information includes a name 1374, mailing address 1375, telephone number 1376, and e-mail 1377. Group 1381 allows the user to combine different contacts together under a common name or type. For example, the user may want to have a group for all members of the user's choir. This allows the user to utilize features such as ring-back tones selection for a group, call controls for a group, ring tones from a group, etc. Call controls include features such as call waiting, call forwarding, etc. Selection scroll allows the user to select features for the contact or group. This may be ring-back tones, ring tones, call controls, etc.

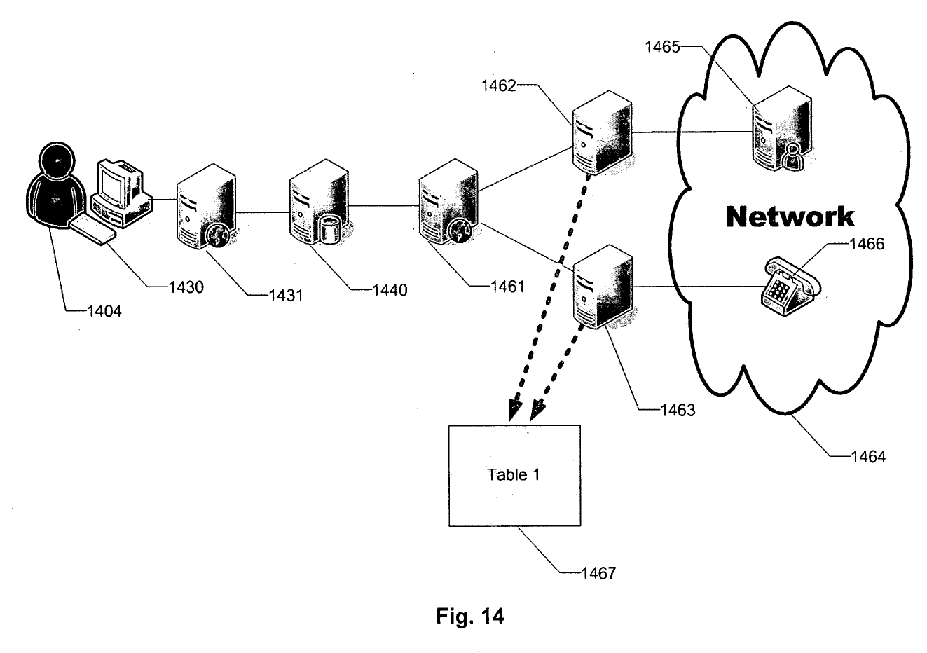

FIG. 14 shows a typical implementation of a provisioning system according to an exemplary embodiment of the present invention. Table 1, shown below, provides sample configuration message formats for the listed service examples.

TABLE 1

| | Provisioning System Interface | | | |
|---|---|---|---|---|
| Service Examples | WTN | TN | Field 1 | Field 2 |
| UM Key Contact List (KCL) (Shared Mbox | 10-digit | Caller TN | | |
| Model) | | | | |
| CVolP Selective Call Acceptance (SCA) | 10-digit | Caller TN | | |
| CVolP Selective Call Rejection (SCR) | 10-digit | Caller TN | | |
| CVolP Selective Call Forward (SCF) | 10-digit | Caller TN | | |
| Ring-back tones (AT) (RBT) | 10-digit | Caller TN | Content ID | End Date |
| Special Ring Tones | 10-digit | Caller TN | Ring-Tone ID | |
| Caller ID Override | 10-digit | Caller TN | Display Name | |

A number of the services listed only need to know the Working Telephone Number (WTN) and caller Telephone Number (TN). Services that are more complex require information fields in addition to the WTN/TN pair. This is the kind of information needed to track changes through to provisioning and it uses a variety of different services as examples. There is a key contact list which provides for special voicemail type telephone notification whenever a message is received from that user or key contact. Selective call acceptance is a way of only taking calls from people on a specified list, while the opposite of that is selective call rejection which is a way of not taking calls from people on a specified list. Another option, selective call forwarding, allows a contact to be forwarded to another telephone number, similar to a find me/follow me service. Next on the table is ring-back tones which are also known as ring back tones. Then the table has special ring tone, which gives different cadence to the rings on a user's home phone. Finally, caller id override is a service that users can have as well which gives a name on the caller ID other than the billing account holder. The default caller ID for every user on a family plan is the billing account holder. This service works to give a more accurate caller ID reading. A user with this kind of a service uses a caller ID override. The name comes out of his own address book as opposed to the network, which provides the billing account holder's name.

Another example of a service is unified messaging. A unified messaging service integrates voicemail, email, and facsimile into a single mailbox. Users can receive an email of their voicemail and listen to their email through voicemail. This is a generalized way to store event related information that is used for alerting the network endpoint of changes. In the exemplary implementation, this is all based on database triggers.

The provisioning interfaces for each of the services have similar data inputs providing an opportunity for code reuse. In FIGS. 9 and 14, the NE² Integrator provides an address book to service integration. The pseudo code shown in FIG. 8 runs in the NE² Integrator. Address book integration costs are lower with the NE² Integrator because existing and vendor supplied provisioning interfaces are not necessarily modified.

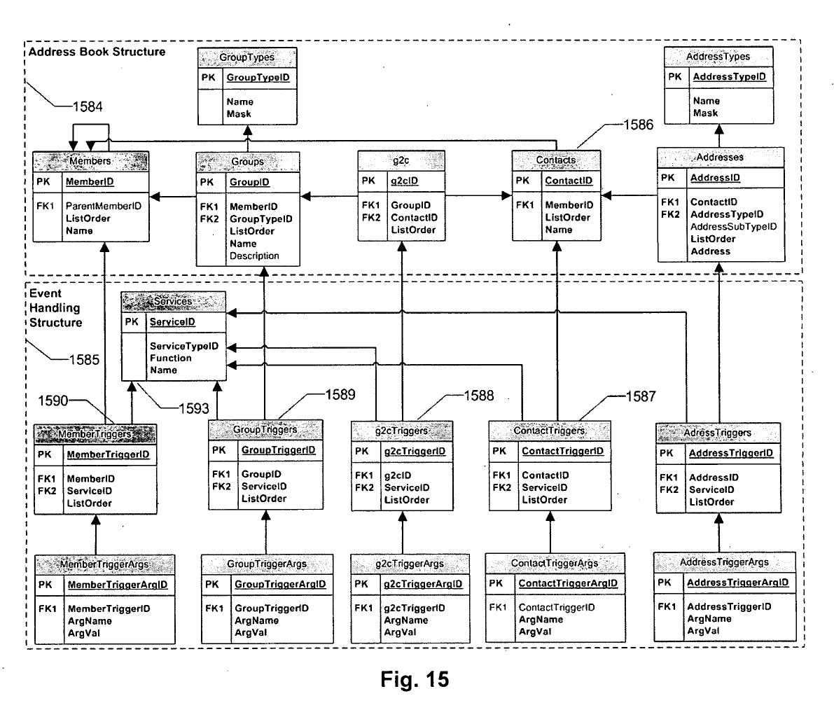

Address book event generation and capture occurs within the address book persistent data store. Changes to address book data stored in a database generate Modern Relational Database Management Systems (RDBMS) support triggers captured and processed within the database. A database trigger is automatically executed procedural code responding to events on a particular table in a database. Triggers capture and respond to events within the address book database. Understanding trigger use in this solution requires understanding the database schema. FIGS. 15 through 17 provide Entity Relationship Diagrams (ERD) of an address book solution logical database design views.

FIG. 15 shows the base network address book logical design, according to an exemplary embodiment of the present invention. The tables within Event Handling Structure 1585 denote items used for event registration and processing. These break down into distinct triggers based on whether the change is an insert, update, or delete, but in many cases the trigger handling is the same. The tables within Address Book Structure 1584 store address book data. Essentially the triggers are directed to the tables that are within the address book structure enabling the analysis engine to see changes and start the reaction engine. The coupling between the analysis and reaction engines occurs swiftly within the database runtime environment. Table 2 further explains the abbreviations in the address book structure of FIGS. 15, 16, and 17:

TABLE 2
Customer Data Tables

| Name | Description |
|---|---|
| Members | A member is an address book. Assume there is one address book per end- |
| | user. A member contains both groups and contacts. |
| Groups | A group is a name given for arbitrary associations of other groups and |
| | contacts. |
| g2g | A group can be a member of many other groups using this many to many |
| | relationship between groups. |
| Group Types | A group type can be one of member defined, system provided, subscribed, |
| | or published. |
| g2c | A contact can be a member of many groups using this many to many |
| | relationship between Groups and Contacts. |
| Contacts | A contact represents an entry in the address book. A contact contains |
| | addresses. |
| Addresses | An address can be a street address, phone number, email address, etc. |
| | The address type determines the actual type of address. |
| Address Types | An address type determines the type of address being stored in a row in the |
| | Addresses table. An address type can be street address, phone number, |
| | email address, etc. |
| Address Subtypes | An address subtype further classifies addresses. For an address type of |
| | telephone number, valid subtypes are mobile, home, office, fax, modem, |
| | etc. (This table is missing from the ERD diagrams.) |
| Publish | When publishing a group in their address book, a customer will add |
| Distribution List | subscribers to this list. |
| Subscribe Status | Subscribe status is one of pending, subscribed, declined, and un- |
| | subscribed. |
| Subscribe | Subscribe permissions grant or deny subscriber capabilities on a published |
| Permissions | group. |

The triggers are code fragments that execute whenever something changes within a table, making up the reaction engine. Table 3 further explains the abbreviations used in the event handling structure of FIGS. 15, 16, and 17:

TABLE 3
Event Registration Tables

| Name | Description |
|---|---|
| Member | A member trigger represents a registered event at the address book level. A |
| Triggers | row in this table identifies the action to take when data changes in a |
| | member's address book. The scope of change includes any data or data |
| | relationships that change contained in the address book. |
| Group Triggers | A group trigger represents a registered event at a group level. A row in this |
| | table identifies action to take when data changes in the group record, member |
| | of groups, or member of contacts. |
| g2g Triggers | Group to group triggers represent registered events at a group level. |
| | Supporting the groups of groups feature requires member of change event |
| | capture. |
| g2c Triggers | Group to contact triggers represent registered events at a group level. |
| | Supporting the multiple groups per contact feature requires member of |
| | change event capture. |
| Contact Triggers | A contact trigger represents a registered event at the contact level. A row in |
| | this table identifies the action to take when data changes in a contact. The |
| | scope of change includes changes to any address data contained within the |
| | contact. |
| Address Trigger | An address trigger represents a registered event at the address level. A row |
| | in this table identifies the action to take when data changes in an address. |
| Publish | A publish distribution list trigger represents a registered event at the publish |
| Distribution List | distribution list level. A row in this table identifies the action to take when data |
| Triggers | changes in a publish distribution list entry. |

The programs look at other database tables. When a user makes a change, such as inserting a contact, the trigger fires. For instance, contacts table 1586 looks to other tables, such as contacts triggers 1587 for registered events. Contacts table 1586 also looks into group to contact (g2c) triggers 1588, group triggers 1589, and member triggers 1590 so that each change in contacts table 1586 also causes a registered event on the whole address book. When a change occurs, the reaction engine triggers a change to service 1593 affected by the change. Events on an address book occur at the member level.

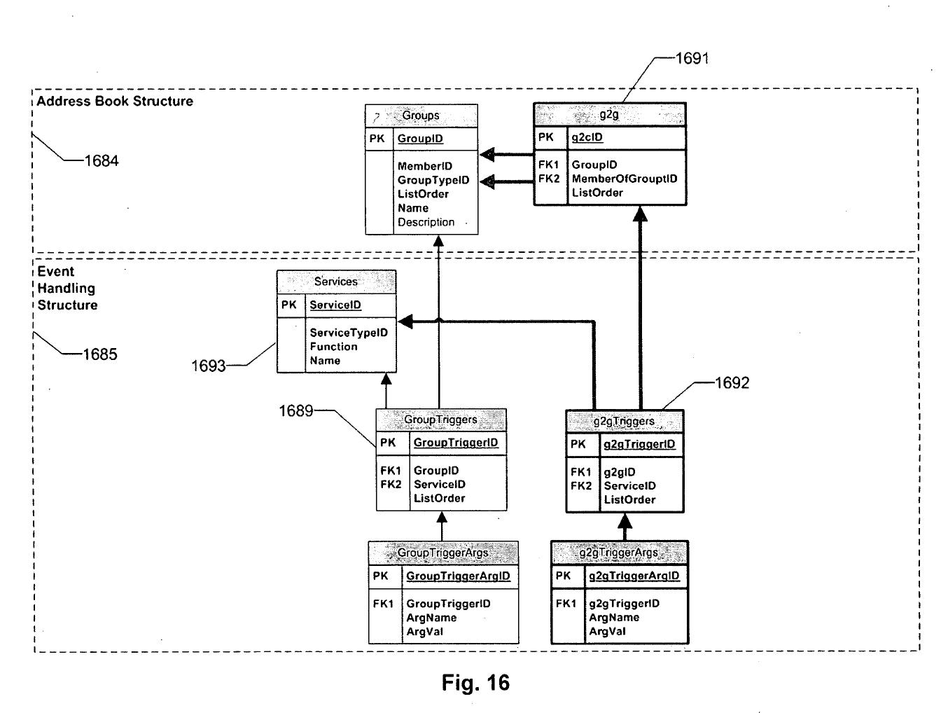

The analysis engine determines whether or not a change in the database is relevant. Relevancy is determined about whether or not a service, external to the address book, is registered to be notified when an event occurs. Missing from FIG. 15 are the tables required to allow a group to be a member of another group. FIG. 16 shows groups of groups support. Adding tables and changing table relationships provides multiple address books per user.

FIG. 16 shows the tables required to support the groups of groups feature of the address book, according to an exemplary embodiment of the present invention. The new tables and relations are group-to-group (g2g) 1691 and g2g triggers 1692. In this embodiment the concept of having groups of groups is present. Here the analysis engine monitors groups of groups for changes, such as a group switching to a new group, or a contact changes groups. When a change occurs, the reaction engine triggers a change to service 1693 affected by the change. However, a complete Network Address Book model requires support for the Publish/Subscribe feature.

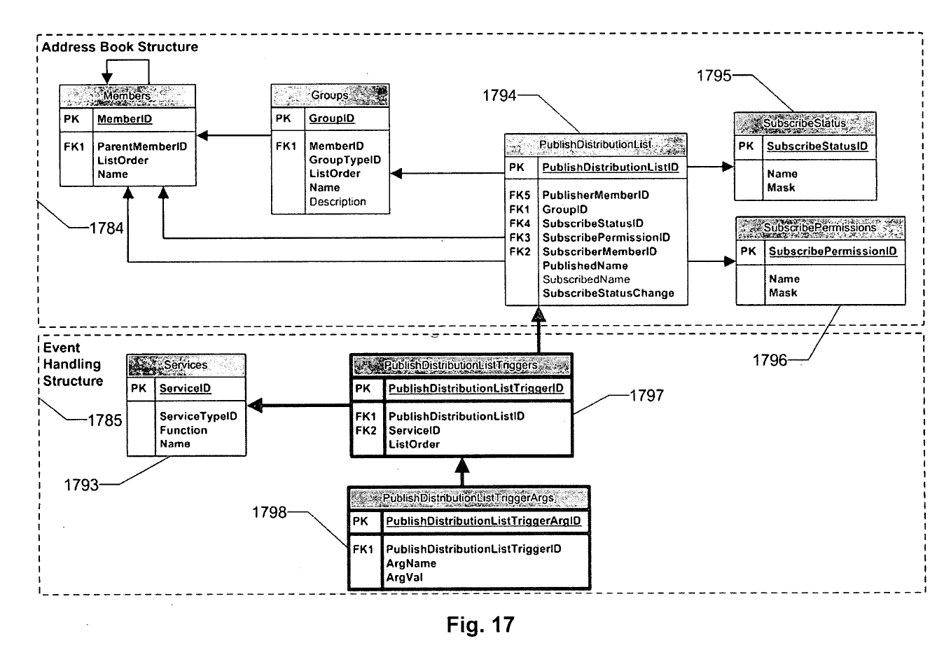

FIG. 17 shows an extension of the event model which covers Publish/Subscribe events, according to an exemplary embodiment of the present invention. Publish/Subscribe data tables 1794, 1795, and 1796 represent the analysis engine where it analyzes changes to other address books. The corresponding event tables 1797 and 1798 represent the triggers of the reaction engine, such as a change to a contact's endpoint address in a colleague's address book. When a change occurs, the reaction engine triggers a change to service 1793 affected by the change. A co-pending application, U.S. Ser. No. 11/345,461, filed Feb. 1, 2006, and entitled, “System and Method of Publishing Contact Information,” describes this publish/subscribe concept in more detail, and is incorporated by reference herein in its entirety.

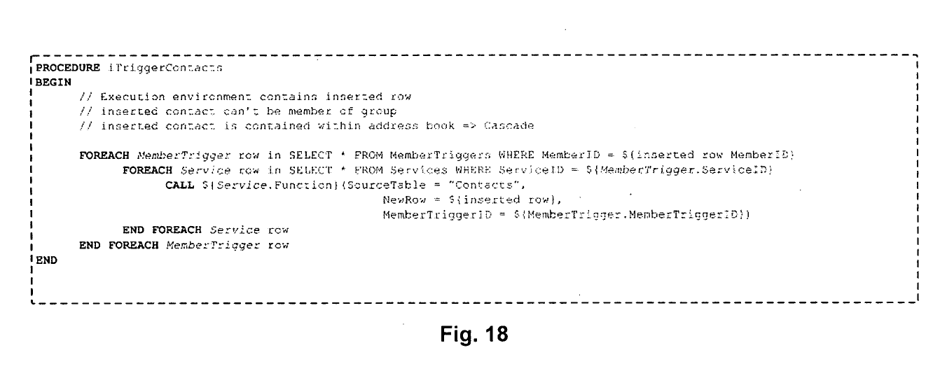

FIG. 18 shows a pseudo-code for a contacts trigger, according to an exemplary embodiment of the present invention. This embodiment of the contacts trigger is executed when a new contact is inserted into an address book. The pseudocode in this embodiment implements uTriggerContacts. uTriggerContacts is executed on updates to the Contacts table. Contact updates cascade through groups and address books.

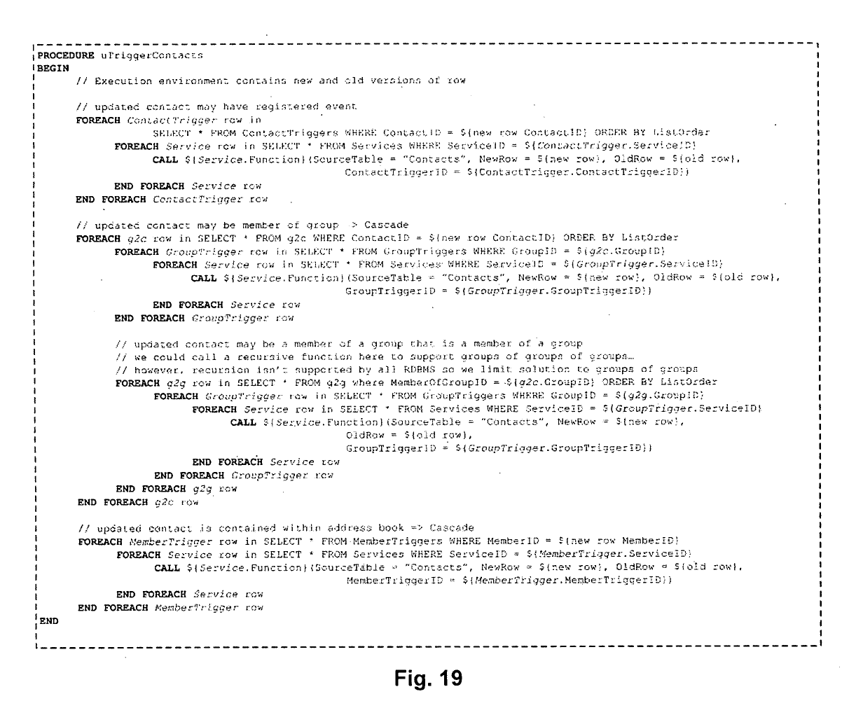

FIG. 19 shows a pseudo-code for a contacts trigger executed when a contact is updated, according to an exemplary embodiment of the present invention. In this embodiment the contact can be part of a group, that group can be part of a larger group, and the contact is always part of an address book. Each case is treated separately through this embodiment to account for all possible service changes required. The pseudocode in this embodiment implements uTriggerContacts. uTriggerContacts is executed on updates to the Contacts table. Contact updates cascade through groups and address books.

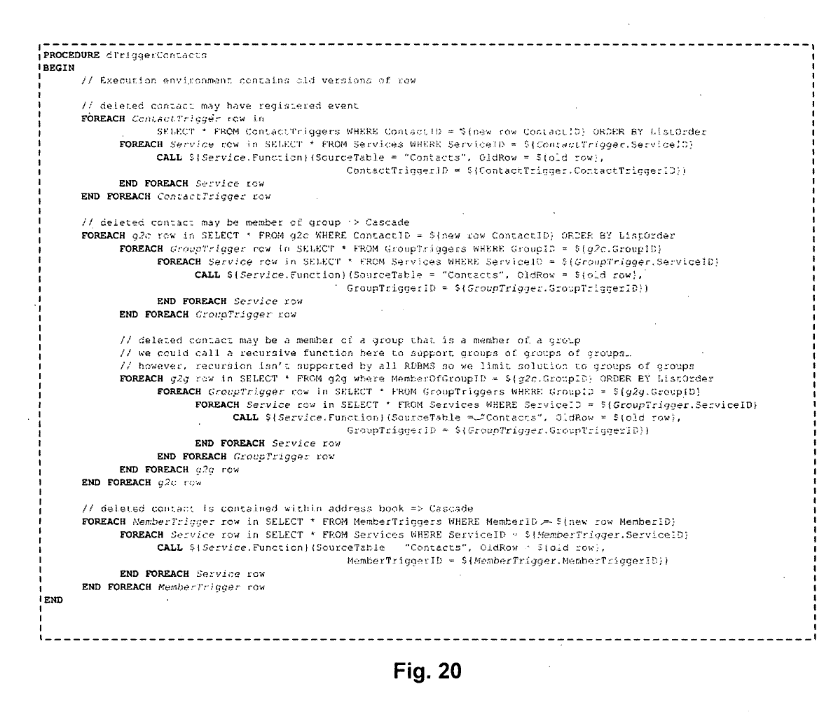

FIG. 20 shows a pseudo-code for a contacts trigger executed when a contact is deleted, according to an exemplary embodiment of the present invention. This embodiment accounts for the contact being part of a group, that group being part of a larger group, and the contact being in an address book. The pseudocode in this embodiment implements dTriggerContacts. dTriggerContacts is executed on delete in the Contacts table.

To maintain referential integrity within the database, deleting rows in the Contacts table 1586 (FIG. 15) requires deleting referencing rows in ContactTriggers 1587. Deleting rows in ContactTriggers 1587 requires deleting referencing rows in ContactTriggerArgs. This process is a cascading delete. Deletes in Contacts 1586 cascade to ContactTriggers 1587, which cascade to ContactTriggerArgs. As is discussed below, deleting a row in ContactTriggers 1587 causes a deregistration event.

Registration/deregistration event implementation is different from insert, update, and delete event processing. Registration/deregistration events do not cascade like insert, update, and delete events. In addition, registration and deregistration activates triggers on different tables within the RDBM.

Refer to FIGS. 15, 16, and 17. Event Registration Tables (described in Table 2) use database triggers. Insert and delete triggers are defined for each Trigger table. To increase readability in the following discussion, there are two triggers for each table named: iTrigger followed by the table name and dTrigger followed by the table name.

For example, the two triggers supporting the ContactTriggers table are iTriggerContactTriggers and dTriggerContactTriggers. An insert in the ContactTriggers table causes the iTriggerContactTriggers trigger to execute. The inserted row is included within the iTriggerContactTriggers execution environment. Deleting a row in the ContactTriggers table causes the dTriggerContactTriggers trigger to execute. The deleted row is included within the dTriggerContactTriggers execution environment. All triggers executed contain copies of the changed data within their execution environment.

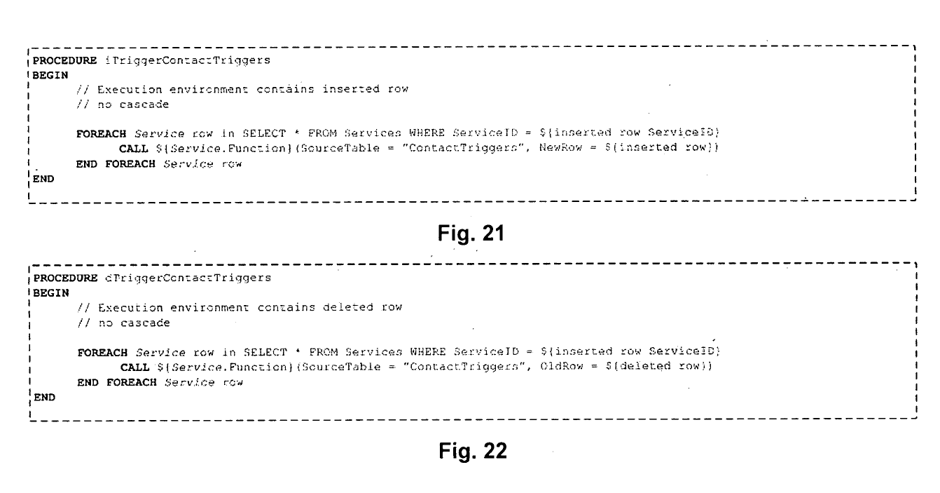

FIG. 21 shows a pseudo-code for a trigger executed when a contacts trigger is executed when a contact is inserted, according to an exemplary embodiment of the present invention. The pseudocode implements iTriggerContactTriggers and is executed on inserts to the ContactTriggers table. This trigger completes event registration by notifying services of registration/deregistration events.

FIG. 22 shows a pseudo-code for a trigger executed when a contacts trigger is executed when a contact is deleted, according to an exemplary embodiment of the present invention. The pseudocode implements dTriggerContactTriggers and is executed on deletes to the ContactTriggers table. This trigger completes event registration by notifying services of registration/deregistration events.

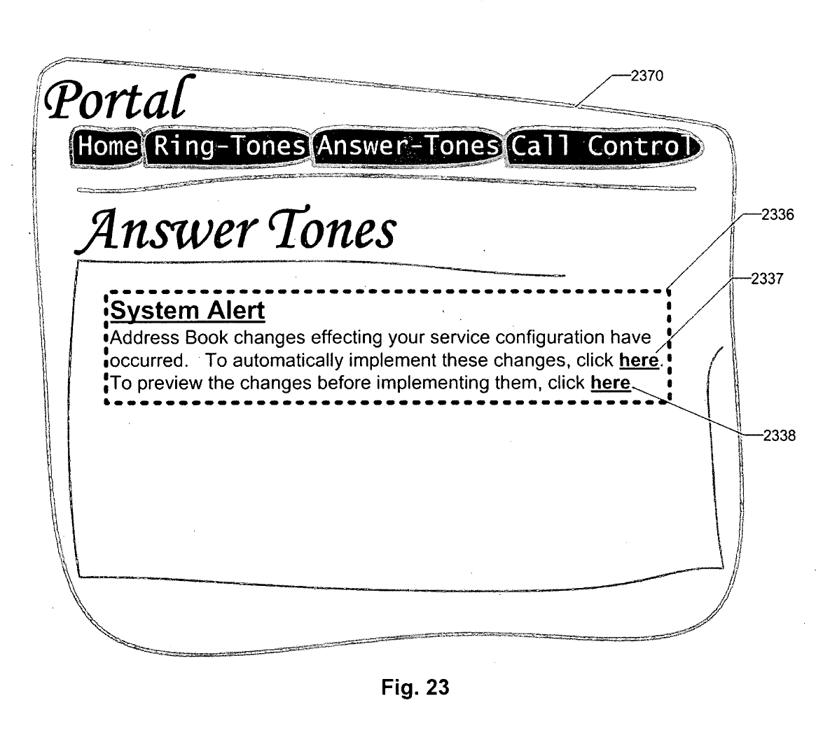

FIG. 23 shows a system alert for deferred configuration, according to an exemplary embodiment of the present invention. In this embodiment, system alert 2336 is sent to a user when the user has made changes to the user's address book which effect one or more of the user's service configurations. The user may implement the changes by clicking on link 2337 or preview the changes first by clicking link 2338. This allows the user to see the changes being made as well as the implications of these changes and confirm that these changes are desired and not accidental.

Deferred configuration changes are implemented later in time. Configuration is initiated by time of day, system load, provisioning system availability, user input, or other conditions. System alerts can be used whenever a change is about to be made to a service, and are user configurable. For instance, a user may elect to receive alerts only when the service change carries a charge.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for updating a service in response to an address book change, comprising:
a communication device;
an electronic address book accessible by the communication device;
an analysis engine in communication with the electronic address book;
a reaction engine in communication with the analysis engine; and
a network controller in communication with the reaction engine;
wherein the analysis engine monitors the electronic address book for changes that impact a service, and the reaction engine updates the network controller when such a change occurs.

2. The system in claim 1, wherein the analysis engine evaluates the change as soon as a user changes the electronic address book.

3. The system in claim 1, wherein the analysis engine comprises a plurality of event registrations, each event registration monitoring an address book object.

4. The system in claim 3, wherein the address book object is one of an endpoint address, a contact, a group of contacts, a group of groups, and a member.

5. The system in claim 1, wherein the reaction engine comprises a plurality of triggers, each trigger executing a change to the service.

6. The system in claim 5, wherein the trigger responds to one of an insert, update, and delete of an address book object.

7. The system in claim 6, wherein the trigger executes another trigger in a cascade.

8. The system in claim 1, wherein the reaction engine defers updating the network controller until a user confirmation.

9. A system for updating a service in response to an electronic address book change, comprising:
an electronic address book;
a server in communication with the electronic address book;
a logic on the server for monitoring and evaluating a change to the electronic address book; and
a network controller in communication with the server;
wherein the logic evaluates whether the change impacts a service and updates the service on the network controller.

10. The system in claim 9, wherein the electronic address book comprises a plurality of electronic address book objects.

11. The system in claim 10, wherein the plurality of electronic address book objects comprises endpoint addresses, contacts, groups, groups of groups, and members.

12. The system in claim 11, wherein the logic comprises an analysis engine and a reaction engine.

13. The system in claim 12, wherein the analysis engine monitors the plurality of electronic address book objects.

14. The system in claim 12, wherein the reaction engine triggers a change to a service impacted by a change to an electronic address book object.

15. The system in claim 9, wherein the logic defers updating the network controller until a user confirmation.

16. A method for updating a service in response to a change in an electronic address book, comprising:
evaluating whether a change impacts a service;
monitoring an electronic address book for the change; and
updating the service with the change.

17. The method in claim 16, further comprising alerting a user before updating the service with the change.

18. The method in claim 17, further comprising requiring a user confirmation before updating the service with the change.

19. The method in claim 16, further comprising registering for a service.

20. The method in claim 19, further comprising selecting an electronic address book object that impacts the service.
